(19) United States
(12) Patent Application Publication
(10) Pub. No.: US 2013/0287961 A1
(43) Pub. Date: Oct. 31, 2013

(54) REVERSIBLE CONTACT ELECTRIFICATION

(71) Applicants: Samuel W. Thomas, III, Andover, MA (US); Simone Friedle, Karlsruhe (DE)

(72) Inventors: Samuel W. Thomas, III, Andover, MA (US); Simone Friedle, Karlsruhe (DE)

(73) Assignee: Tufts University, Medford, MA (US)

(21) Appl. No.: 13/702,376

(22) PCT Filed: Jun. 7, 2011
(86) PCT No.: PCT/US2011/039395

§ 371 Date: Jul. 12, 2013

Related U.S. Application Data
(60) Provisional application No. 61/352,034, filed on Jun. 7, 2010.

(51) Int. Cl. B05D 7/00

(52) U.S. Cl. CPC B05D 7/00
USPC 427/458

(57) ABSTRACT

A method for modifying surface charges created by contact electrification includes providing a polymer formed of a plurality of monomers each containing a functional group capable of reversibly switching between a first structure and a second structure different from the first structure, the functional group having the first structure; contact-charging the polymer with a surface such that the polymer carries a first net surface charge; and converting the first structure of the functional group to the second structure. The sequence of the contact-charging and converting steps can be switched.

### CROSS-REFERENCE TO RELATED APPLICATIONS

This application claims the priority of U.S. provisional application No. 61/352,034, filed on Jun. 7, 2010, the contents of which are hereby incorporated by reference in their entirety.

### BACKGROUND

Control over static electricity, particularly on insulating materials, is a major problem in a number of fields, including electronics manufacturing, copying/printing, and the petroleum industry. Electrical discharge can be dangerous, especially around highly flammable materials. Controlling the spatial distribution of static charge is critical in many patterning technologies, especially laser printing and Xerography.

Currently, strategies for controlling electrical discharge focus on increasing conductivity, such as conductive fibers in Nylon carpets and topical antistatic coatings. Patterning of electrostatic charge is typically performed with irradiation of an electrically charged photoconductor, such that those areas irradiated with light conduct that charge to ground.

### SUMMARY

The invention, at least in part, is based on a discovery that certain polymers can reversibly change their triboelectric properties (e.g., the sign of the net surface charge upon contact electrification or the rate of charge separation via contact electrification) by changing their molecular structures or configurations, e.g., transformation between trans- and cis-isomers or that between non-ionic and zwitterionic isomers. For instance, it has been found that films containing a copolymer that possesses certain photochromic moieties (e.g., nitrospiropyran) unexpectedly exhibited one or more of three types of behavior upon UV irradiation: i) increased its rate of positive charging, ii) decreased its rate of negative charging, and iii) switched from negative to positive charging. Yet, before irradiation, the triboelectric properties of nitrospiropyran-containing copolymer films were similar to that of the homopolymer of the inert monomer.

1. In one aspect, the invention relates to a method for modifying surface charges created by contact electrification. The method of this invention includes (1) providing a polymer possessing a functional group capable of reversibly switching between a first structure and a second structure different from the first structure, the functional group having the first structure; contact-charging the polymer with a surface such that the polymer carries a net surface charge; and switching the first structure of the functional group to the second structure. The sequence of the contact-charging and converting steps can be performed in a reversed order or simultaneously. The method of this invention may also include, after the converting step, heating the polymer at a temperature between 20° C. and 150° C. (or between 50° C. and 100° C.) or exposing the polymer to an irradiation of a second wavelength different from the first wavelength, thereby switching the functional group back to have the first structure.

The above-described method modifies surface charges on both the polymer and the surface used in the contact-charging step.

In another aspect, this invention relates to a method of preparing a polymer surface, which has reversible triboelectric properties. The method includes polymerizing monomers having a photochromic, electrochromic, or thermochromic group (e.g., nitrospiropyran methacrylate) with or without a comonomer (e.g., methacrylate), and converting the polymer to an article having the desired surface.

The details of one or more embodiments of the invention are set forth in the description below and in the drawings. Other features, objects, and advantages of the invention will be apparent from the description, from the drawings, and from the claims.

### BRIEF DESCRIPTION OF DRAWINGS

FIG. 1 includes three reaction schemes for synthesizing photochromic monomers.

FIG. 2 is a schematic illustration of an apparatus for measuring charges caused by contact electrification.

FIG. 3 includes two graphs showing charges of a steel sphere rolling on a photochromic polymer before and after UV irradiation using 200 W Hg/Xe OF Lamp (UV bandpass filter 260-380 nm).

FIG. 4 include three graphs showing reversible charging behavior of spiropyran polymer.

### DETAILED DESCRIPTION OF INVENTION

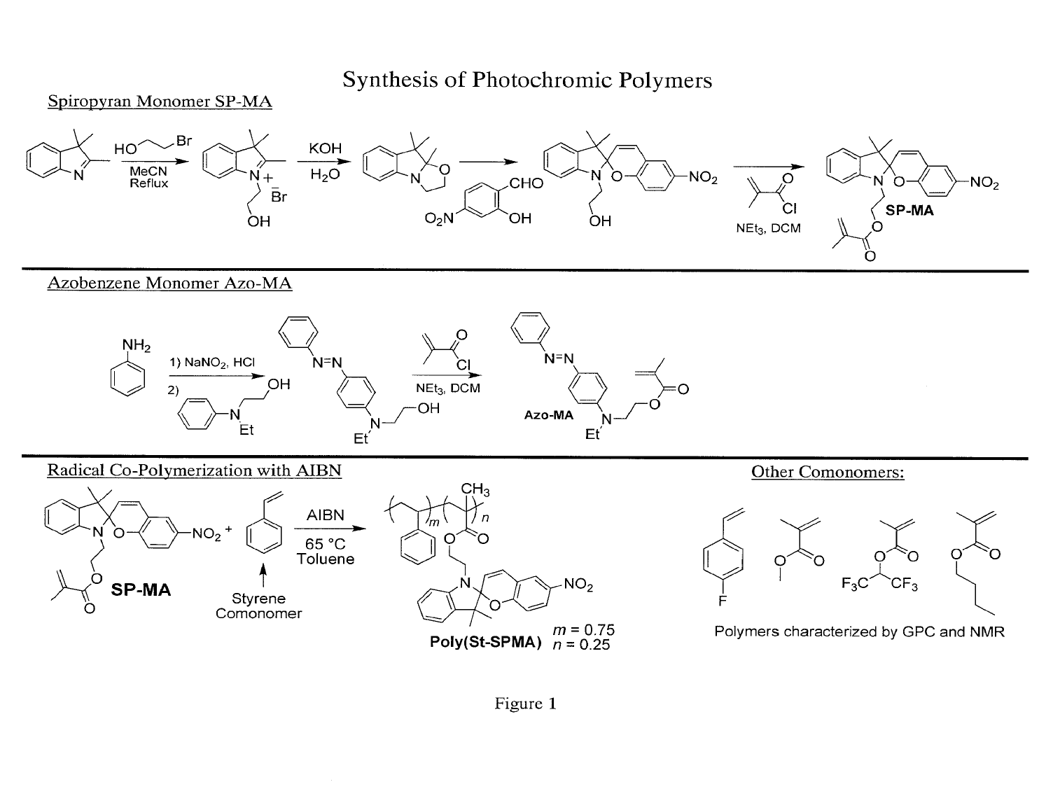

To practice this invention, one first provides a polymer possessing one or more functional groups capable of reversibly switching between different structures. Examples of the backbone of the polymer include, but are not limited to polycarbonate, polyester, polyamide, and polyacrylate. Examples of the functional groups include, but are not limited to a photochromic group (e.g., spiropyran, azobenzene, dithienylethene, spriooxazine, and chromene), an electrochromic group (e.g., bipyridinium), or a thermochromic functional group (e.g., bisphenol A, parabens, 1,2,3-triazole derivates, and 4-hydroxycoumarin). The polymer can be prepared by polymerization of monomers each containing such a functional group. Synthesis of monomers having a photochromic, electrochromic, or a thermochromic group has been reported. See, e.g., F. M. Raymo et al., J. Org. Chem. 2003, 68, 4158 and F. M. Raymo et al, J. Am. Chem. Soc. 2001, 123, 4651. FIG. 1 shows reaction schemes for preparing methacrylate monomers, each of which contains a photochromic group.

The polymer can be either a homopolymer or a copolymer. An example of a homopolymer is polyacrylate containing azobenzene. An example of a copolymer is one formed of methacrylate monomer containing a photochromic group (MMPG) and a comonomer such as alkyl methacrylate (e.g., methyl methacrylate, n-butylmethacrylate, or hexafluoroisopropyl methacrylate) or styrene optionally substituted with halo (e.g., unsubstituted styrene or 4-fluorostyrene). In the copolymer has a molar ratio of the MMPG to the comonomer can be 1:99 or greater (e.g., between 1:9 and 1:1). As the polymer (either homopolymer or copolymer) has a triboelectric effect, it can be applied over a substrate, therefore changing the triboelectric property of the substrate.

One then subjects the polymer to a contact-charging process, e.g., contact electrification or tribocharging. When the polymer is brought into contact with a surface (e.g., a solid surface) and subsequently separated (with or without intentional rubbing or frictional contact), charge transfers between the surface and the polymer. The surface used for the contact-charging step is a surface of a material different from the polymer, e.g., a metal or a different polymer. The material is preferably a conductor. Neither the polymer nor the surface has a net surface charge prior to the contact-charging step.

During or after the contact-charging process, one converts the structure of the functional group to another structure. The converting step is performed, e.g., by exposing the polymer to an irradiation of a first wavelength. For instance, spiropyran is converted from its non-ionic phase to a zwitterionic phase by a UV irradiation. The method of this invention can further include, after the converting step, heating the polymer at a temperature between 10° C. and 200° C. (e.g., between 20° C. and 150° C., or between 50° C. and 100° C.) or exposing the polymer to an irradiation of a second wavelength different from the first wavelength, thereby switching the structure of the functional group back to the first structure.

The converting step can also be performed by heating the polymer at a temperature between 10° C. and 200° C. (e.g., between 20° C. and 150° C., or between 50° C. and 100° C.). For instance, spiropyran is converted from its zwitterionic phase to the non-ionic phase by heating polymer containing spiropyran at 60° C. for a few hours or maintaining the polymer at room temperature without UV irradiation. If desired, the method of this invention can also include, after the converting step, exposing the polymer to an irradiation of a third wavelength, e.g., converting spiropyran from its non-ionic phase back to the zwitterionic phase by a UV irradiation.

The method of this invention can further include, after the converting step, subjecting the polymer to a second contact-charging step with the surface such that the polymer carries a second net surface charge. The first net surface charge and the second net surface charge have opposite signs. For example, the first net surface charge can be positive and the second net surface charge can be negative. As another example, the first net surface charge and the second net surface charge can have the same sign but different charge densities. The term “charge density” refers to the amount of surface charges per unit area. It depends on the polymer's triboelectric properties, more specifically, the rate of charge separation via contact electrification.

The term “alkyl” refers to a straight or branched hydrocarbon group, containing 1-10 carbon atoms. It can be both substituted and unsubstituted.

Among other advantages, the method described herein (i) does not require any applied potential, (ii) directly changes the sign of contact electrification with light, as opposed to merely whether or not a material holds its applied potential, (iii) changes the sign of contact electrification reversibly, (iv) allows directly controlling the sign and rate of charge separation via contact electrification by changing the surface chemistry, as opposed to mitigating accumulated charge through increased conductivity, and (v) controls not only whether a material charges or not, but also the sign of the charge that develops, making it potentially more versatile.

The method described herein finds application in areas such as tunable anti-static surfaces; reconfigurable templates for electrostatic self-assembly for use in parallel precision manufacturing; electrostatic actuators that use light and contact/agitation to actuate over small distances, for potential use in a micro-electro-mechanical system; electrostatic forces control between solids and/or liquids; and chemical sensing, especially in the vapor phase, where the “readout” is an electrostatically self-assembled pattern of particles. See, e.g., S. W. Thomas, et al, J. Am. Chem. Soc., 2009, 131, 8746-8747; D. M. Pai, et al., Rev. Mod. Phys. 1993, 65, 163. J. Dalin, et al., Microelectron. Eng. 2010, 87, 159; R. C. Anderson, et al., Icarus 2009, 204, 545; C. J. Morris, et al., IEEE Trans. Adv. Packag. 2005, 28, 600; and M. Glor, J. Electrostat. 2005, 63, 447.

All of the publications cited herein are hereby incorporated by reference in their entirety.

Without further elaboration, it is believed that the above description has adequately enabled the present invention. The following examples are, therefore, to be construed as merely illustrative, and not limitative of the remainder of the disclosure in any way whatsoever.

### EXAMPLES

Different photochromic polymers (polymers with reversible photochemical transitions), most of which were based on methacrylate polymers, were synthesized from monomers containing photochromic groups according to methods reported in the literature. See FIG. 1.

Copolymers of 25% nitrospiropyran (SP)-containing methacrylic monomer and 75% of either styrene-based or methacrylate-based comonomers via radical polymerization in toluene at 65° C. The number-average molecular weights (M_{N}) of the polymers were 10-15×10⁴ g/mol. As determined by ¹H NMR, the ratio of functional groups in the polymers was the same as the molar ratio of monomers in the polymerization reaction. Spin-casting these polymers from 1% solutions (w/v) in toluene onto glass slides at 2500 rpm gave optically clear films that were approximately 100-500 nm thick.

As expected, the SP-containing polymer films turned blue upon irradiation with UV light due to formation of MC moieties. In addition, the hydrophilicity of the film increased upon UV irradiation. Polymers without SP groups showed no change in absorbance spectrum or contact angle after UV irradiation.

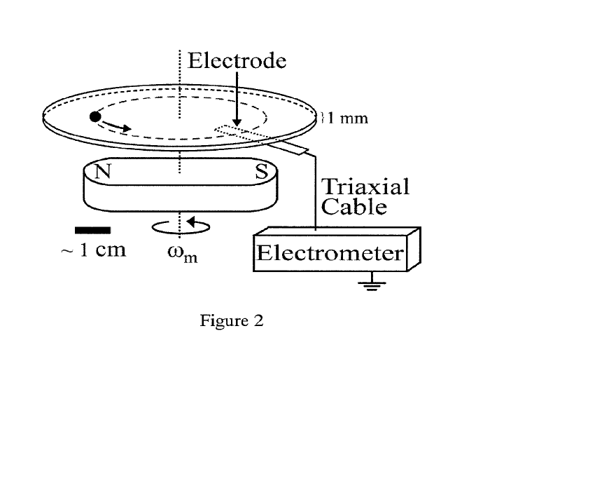

To measure the dynamics of contact electrification, an experimental apparatus shown in FIG. 2 was used. This apparatus uses a magnetic stir plate to cause a ferromagnetic steel sphere to roll in a circle on a planar dielectric (e.g., a wafer coated with a photochromic polymer to be tested). Each time the sphere completes its circular path it passes over an electrode (connected to an electrometer) that measures the charge on the sphere inductively. When the sphere is far (>˜2.5 cm) from the electrode, the electrode measures only the charge on the dielectric surface that is close to the electrode. This apparatus has several advantages: (i) the execution of experiments is rapid; (ii) the measurement is non-invasive; (iii) the amount of charge on both contacting surfaces as a function of time can be measured quantitatively; and (iv) the components are simple and inexpensive.

Copolymers of spiropyran methacrylate (SPMA) and a comonomer selected from methyl methacrylate (MMA), n-butylmethacrylate, hexafluoroisopropyl methacrylate, styrene, and 4-fluorostyrene (FSt) were tested.

It was observed that a steel sphere rolling on a film of copolymer of SPMA-FSt charged positively before UV irradiation of the film and charged negatively after the irradiation. The same behavior was observed when the experiment was conducted in an atmosphere of N₂ or when the SP group was irradiated selectively at 365 nm. Therefore, neither oxidative decomposition of the SP nor photochemical reaction of the polymer backbone caused the change in charging upon UV irradiation.

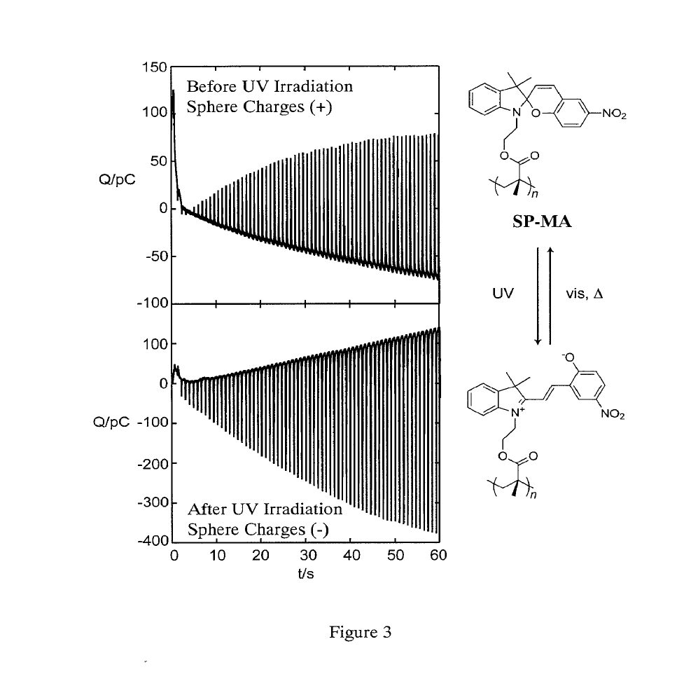

FIG. 3 shows representative unprocessed data for the charging of a polymer before and after irradiation. The polymer was prepared by copolymerizing 25% spiropyran methacrylate (SP-MA) and 75% methyl methacrylate (MMA). Before irradiation, the rolling steel sphere charged positively, whereas after irradiation it charged negatively. It was observed that the sphere had an increased tendency to charge negatively after irradiation than before irradiation regardless of which comonomer the spiropyran was polymerized with.

The rate and sign of charging of the rolling steel sphere depended on which of two states the polymer was in. In the colorless “ring closed” SP state, the sign of charging of the sphere could be either positive or negative, depending on the structure of the polymeric backbone. Upon irradiation with UV light (260-400 nm) the spiropyran undergoes a ring-opening reaction. This blue-colored “ring-open” MC state caused the rolling sphere to develop a negative charge, usually at a much faster rate than it did before irradiation.

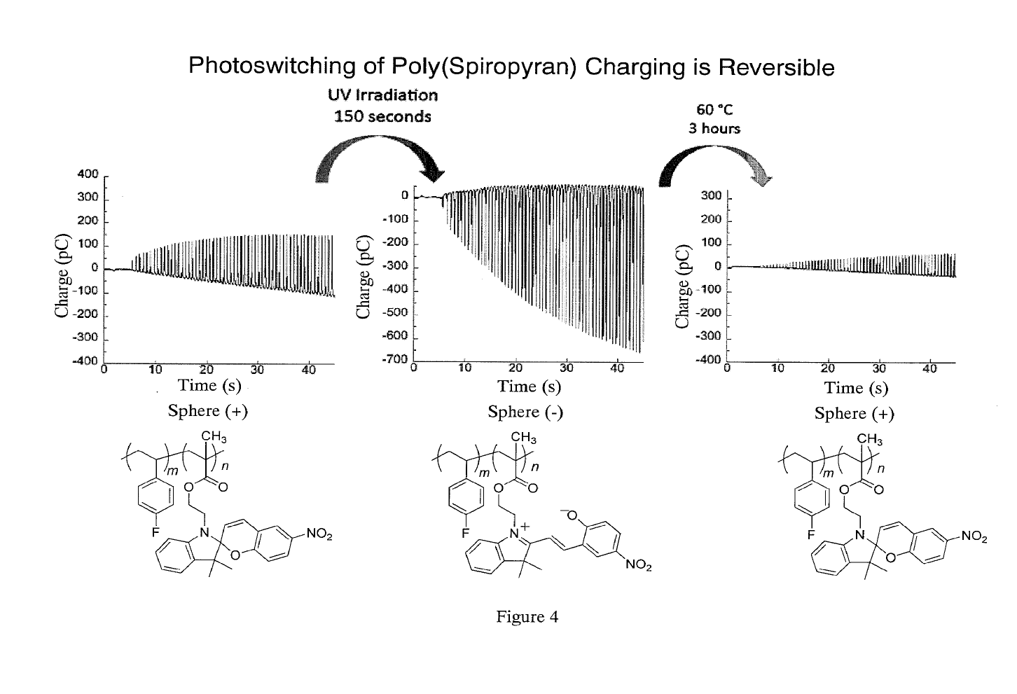

The switching of charging behavior of these films was reversible. As shown in FIG. 4, consistent with the photochromic nature of spiropyrans, the UV/vis spectra and contact angles of irradiated films reversed to the SP state after 3 hours at 60° C. Concurrently, the rate of charging became characteristic of the unirradiated film, e.g., spheres rolling on PS derivatives charged positively upon heating the film. Following this reversal from MC to SP, additional UV irradiation recovered ˜80% of the MC absorbance at ˜600 nm wavelength, decreased the advancing and receding contact angles, and again caused the sphere to charge negatively. Although these films showed fatigue of photochromisim after a few cycles by monitoring the UV/vis spectra, switching the sign of contact electrification reversibly will be important for future applications of this new class of responsive materials. This reversibility provides strong evidence for attributing the switching of charging behavior to the SP-MC interconversion.

### Other Embodiments

All of the features disclosed in this specification may be combined in any combination. Each feature disclosed in this specification may be replaced by an alternative feature serving the same, equivalent, or similar purpose. For example, the polymer after converting to a different structure, can be contact-charged with a surface different from the surface used in the initial contact charging step. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

1. A method for modifying surface charges created by contact electrification, the method comprising:
providing a polymer possessing one or more functional groups capable of reversibly switching between a first structure and a second structure different from the first structure, the functional group having the first structure;
contact-charging the polymer with a surface such that the polymer carries a first net surface charge; and
converting the first structure of the functional group into the second structure.

2. The method of claim 1, wherein the surface is a surface of a material different from the polymer.

3. The method of claim 2, wherein the material is a conductor.

4. The method of claim 1, wherein neither the polymer nor the surface has a first net surface charge prior to the contact-charging step.

5. The method of claim 2, further comprising, after the converting step, subjecting the polymer to a second contact-charging step with the surface such that the polymer carries a second net surface charge.

6. The method of claim 5, wherein the first net surface charge and the second net surface charge have opposite signs.

7. The method of claim 5, wherein the first net surface charge and the second net surface charge have the same sign but different densities.

8. The method of claim 1, wherein the functional group is a photochromic group.

9. The method of claim 8, wherein the surface is a surface of a material different from the polymer.

10. The method of claim 9, wherein the material is a conductor.

11. The method of claim 8, wherein neither the polymer nor the surface has a first net surface charge prior to the contact-charging step.

12. The method of claim 1, further comprising, after the converting step, subjecting the polymer to a second contact-charging step with the surface such that the polymer carries a second net surface charge.

13. The method of claim 12, wherein the first net surface charge and the second net surface charge have opposite signs.

14. The method of claim 12, wherein the first net surface charge and the second net surface charge have the same sign but different densities.

15. The method of claim 8, wherein the photochromic group is spiropyran, azobenzene, dithienylethene, spriooxazine, or chromene.

16. The method of claim 8, wherein the converting step is performed by exposing the polymer to an irradiation of a first wavelength.

17. The method of claim 16, further comprising, after the converting step, heating the polymer at a temperature between 20° C. and 150° C. or exposing the polymer to an irradiation of a second wavelength different from the first wavelength, thereby switching the functional group back to have the first structure.

18. The method of claim 8, wherein the converting step is performed by heating the polymer at a temperature between 20° C. and 150° C.

19. The method of claim 18, further comprising, after the converting step, exposing the polymer to an irradiation of a third wavelength, thereby switching the functional group back to have the first structure.

20. The method of claim 8, wherein each of the monomers is a methacrylate monomer containing a photochromic group (MMPG).

21. The method of claim 20, wherein the polymer is a copolymer formed of MMPG and a comonomer different from MMPG.

22. The method of claim 21, wherein the comonomer is a vinyl monomer.

23. The method of claim 22, wherein the vinyl comonomer is alkyl methacrylate or styrene optionally substituted with halo.

24. The method of claim 23, wherein the alkyl methacrylate is methyl methacrylate, n-butylmethacrylate, or hexafluoroisopropyl methacrylate.

25. The method of claim 23, wherein styrene is unsubstituted styrene or 4-fluorostyrene.

26. The method of claim 21, wherein the polymer has a molar ratio of MMPG to the comonomer equal to or greater than 1:99.

27. The method of claim 21, wherein the polymer has a molar ratio of MMPG to the comonomer between 1:9 and 1:1.

28. The method of claim 20, wherein the polymer is a homopolymer.

29. The method of claim 28, wherein the photochromic group is azobenzene.

30. The method of claim 1, wherein the providing step is performed by coating the polymer over a substrate.
